(19) United States
(12) Patent Application Publication
(10) Pub. No.: US 2022/0112390 A1
(43) Pub. Date: Apr. 14, 2022

(54) WATER-BASED INK FOR INK-JET RECORDING AND INK-JET RECORDING APPARATUS

(71) Applicant: Brother Kogyo Kabushiki Kaisha, Nagoya (JP)

(72) Inventors: Hirofumi Kuriki, Nagoya (JP); Shunichi Higashiyama, Yokkaichi (JP); Taro Nagano, Nagoya (JP)

(21) Appl. No.: 17/538,150

(22) Filed: Nov. 30, 2021

Related U.S. Application Data
(63) Continuation of application No. PCT/JP2020/013084, filed on Mar. 24, 2020.

(30) Foreign Application Priority Data
May 31, 2019 (JP) 2019-102153

(51) Int. Cl. C09D 11/38; C08K 5/053; C08L 71/02; C08L 27/06; C08L 33/08; B41J 11/00

(52) U.S. Cl. CPC C09D 11/38; C08K 5/053; C08L 71/02; C08L 2201/52; C08L 33/08; B41J 11/002; C08L 27/06

(57) ABSTRACT

A water-based ink for ink-jet recording includes: a water-soluble organic solvent; water; and a surfactant having solubility in the water at 20° C. in a range of 0.05% by mass to 0.2% by mass, a content amount of the surfactant in an entire amount of the water-based ink being not less than 1% by mass.

### CROSS REFERENCE TO RELATED APPLICATIONS

This application is a Continuation application of International Application No. PCT/JP2020/013084 which was filed on Mar. 24, 2020 claiming the conventional priority of Japanese patent Application No. 2019-102153 filed on May 31, 2019. The disclosures of Japanese patent Application No. 2019-102153 and International Application No. PCT/JP2020/013084 are incorporated herein by reference in their entirety.

### BACKGROUND

The present disclosure relates to a water-based ink for ink-jet recording and an ink-jet recording apparatus.

There is proposed a water-based ink containing a vinyl chloride-acrylic based copolymer, as a water-based ink for ink-jet recording which has an excellent fixing property to coated paper, etc.

### SUMMARY

There is a demand, however, for a new water-based ink for ink-jet recording which has a satisfactory wettability with respect to a recording medium having hydrophobicity such as coated paper, plastic, film, etc., of which ink droplet spreads on a surface of the hydrophobic recording medium, and which is capable of filling a predetermined area of the hydrophobic recording medium with a small amount thereof.

In view of the above situation, an object of the present disclosure is to provide a new water-based ink for ink-jet recording which has a satisfactory wettability with respect to a recording medium having hydrophobicity, of which ink droplet spreads on a surface of the hydrophobic recording medium, and which is capable of filling, with a small amount thereof, a predetermined area of the hydrophobic recording medium.

According to a first aspect of the present disclosure, there is provided a water-based ink for ink jet recording, including:

a water-soluble organic solvent;

water; and

a surfactant.

The surfactant has solubility in the water at 20° C. in a range of 0.05% by mass to 0.2% by mass. A content amount of the surfactant in an entire amount of the water-based ink is not less than 1% by mass.

According to a second aspect of the present disclosure, there is provided an ink-jet recording apparatus including:

an ink storage storing the water-based ink for ink jet recording of the first aspect;

and an ink-jet head configured to discharge the ink stored in the ink storage.

According to a third aspect of the present disclosure, there is provided an ink-jet recording method including discharging, onto a recording medium, the water-based ink for ink-jet recording of the first aspect.

### BRIEF DESCRIPTION OF THE DRAWINGS

FIG. 1 is a schematic view depicting the configuration of an example of an ink-jet recording apparatus related to the present disclosure.

### DETAILED DESCRIPTION

In the present disclosure, a phrase such as a “surfactant having solubility in water at 20° C., that is X % by mass” means a surfactant of which maximum amount to dissolve in (100−X) g of water at 20° C. is Xg. For example, a phrase such as “surfactant having solubility in water at 20° C., that is 0.2% by mass” means a surfactant of which maximum amount to dissolve in 99.8 g of water at 20° C. is 0.2 g.

A water-based ink for ink-jet recording related to the present disclosure (hereinafter also referred to as a “water-based ink” or an “ink”, in some cases) is suitably usable in an ink-jet recording onto a recording medium having hydrophobicity such as, for example, coated paper, plastic, film, an OHP sheet, etc., but is not limited to or restricted by this usage. The water-based ink for ink-jet recording related to the present disclosure is also usable, for example, in the ink jet recording onto a recoding medium which is different from the hydrophobic recording medium and which includes, for example, regular paper (plain paper), glossy paper, mat paper, etc. In the present disclosure, the term “coated paper” means, for example, paper obtained by coating, with a coating agent, regular paper of which main constituent is pulp, such as high-grade print paper and middle-grade print paper. The coating agent is applied to the regular paper to improve its smoothness, whiteness, brightness, etc. The coated paper is exemplified by high-grade coated paper, middle-grade coated paper, etc.

The water-based ink related to the present disclosure will be explained. The water-based ink related to the present disclosure contains a surfactant, a water-soluble organic solvent and water.

The surfactant is such a hydrophobic surfactant wherein the solubility in the water at 20° C. is in the range of 0.05% by mass to 0.2% by mass, and is hardly dissolved to water. The surfactant may, for example, include at least one of an acetylene glycol-based surfactant and a polyoxyethylene-based surfactant. A commercial available product may be used as the surfactant. The commercially available product is exemplified, for example, by: “OLFINE (trade name) E1004” (acetylene glycol-based) and “SURFYNOL (trade name) 440” (acetylene glycol-based) which are produced by NISSHIN CHEMICAL CO., LTD.; “EMULGEN (trade name) 106” (polyoxyethylene lauryl ether) and “EMULGEN (trade name) 705” (polyoxyethylene alkyl ether) which are produced by KAO CORPORATION; “NONION P-210” (polyoxyethylene cetyl ether) produced by NOF CORPORATION; “ACETYLENOL (trade name) E40” (acetylene glycol-based) produced by KAWAKEN FINE CHEMICALS CO., LTD.; etc. The surfactant may have the solubility in water at 20° C., for example, in a range of 0.05% by mass to 0.1% by mass. In the present disclosure, the term “acetylene glycol-based surfactant” means a surfactant which is an acetylene glycol-based compound having polyoxyethylene chain or no polyoxyethylene chain; and the term “polyoxyethylene-based surfactant” means a surfactant which is not the acetylene glycol-based compound and which has polyoxyethylene chain.

The content amount of the hydrophobic surfactant in the entire amount of the water-based ink is not less than 1% by mass. By containing not less than 1% by mass of the hydrophobic surfactant, the water-based ink has a satisfactory wettability with respect to a hydrophobic recording medium, an ink droplet of the water-based ink spreads on a surface of the hydrophobic recording medium, and a small amount of the water-based ink is capable of filling a predetermined area in the hydrophobic recording medium. The upper limit of the content amount of the hydrophobic surfactant is not particularly limited. Since the hydrophobic surfactant is required to be dissolved in the water-based ink, the upper limit is, for example, in a range of approximately 4% by mass to approximately 5% by mass, although depending on the blending amount(s) of other component(s), such as the above-described water-soluble organic solvent, etc. Namely, the content amount of the hydrophobic surfactant in the entire amount of the water-based ink may be not more than 5% by mass, or not more than 4% by mass. Accordingly, the content amount of the hydrophobic surfactant in the entire amount of the water-based ink may be, for example, in a range of 1% by mass to 5% by mass, in a range of 1% by mass to 4% by mass, in a range of 1.2% by mass to 2.7% by mass, or in a range of 1.3% by mass to 2.5% by mass.

It is allowable that only the hydrophobic surfactant is contained in the water-based ink, as the surfactant thereof. Alternatively, the water-based ink may further contain, in addition to the hydrophobic surfactant, another surfactant which is different from the hydrophobic surfactant.

The water-soluble organic solvent may include at least one selected from the group consisting of: propylene glycol, 1,3-butanediol, tripropylene glycol (hereinafter referred to as “TPG”, in some cases) and diethylene glycol (hereinafter referred to as “DEG”, in some cases). The above-listed water-soluble organic solvents may function, for example, as a humectant which prevents the water-based ink from drying at an end of a nozzle in an ink-jet head. The content amount of the water-soluble organic solvent in the entire amount of the water-based ink may be, for example, not less than 10% by mass. The upper limit of the content amount of the water-soluble organic solvent is not particularly limited, and the upper limit value may be, for example, not more than 50% by mass. Further, from the viewpoint of allowing the hydrophobic surfactant to dissolve, the content amount of the water-soluble organic solvent in the entire amount of the water-based ink may be, for example, not less than 20% by mass, or in a range of 20% by mass to 40% by mass.

The water-soluble organic solvent included in the water-based ink may be only at least one selected from the groups consisting of: propylene glycol, 1,3-butanediol, TPG and DEG. Namely, it is allowable that the water-soluble organic solvent does not include any water-soluble organic solvent which is different from the propylene glycol, 1,3-butanediol, TPG and DEG. Alternatively, the water-soluble organic solvent may further contain a humectant which is different from the propylene glycol, 1,3-butanediol, TPG and DEG. The humectant different from the propylene glycol, 1,3-butanediol, TPG and DEG is not particularly limited, and may be exemplified, for example, by: by lower alcohols such as methyl alcohol, ethyl alcohol, n-propyl alcohol, isopropyl alcohol, n-butyl alcohol, sec-butyl alcohol, tert-butyl alcohol, etc.; amides such as dimethylformamide, dimethylacetamide, etc.; ketones such as acetone, etc.; ketoalcohols (ketone alcohols) such as diacetone alcohol, etc.; ethers such as tetrahydrofuran, dioxane, etc.; polyethers such as polyalkylene glycol, etc.; polyvalent alcohols such as alkylene glycol which is different from the propylene glycol, 1,3-butanediol, TPG and DEG, glycerol, trimethylolpropane, trimethylolethane, etc.; 2-pyrrolidone; N-methyl-2-pyrrolidone; 1,3-dimethyl-2-imidazolidinone; and the like. The polyalkylene glycol is exemplified, for example, by polyethylene glycol, polypropylene glycol, etc. The alkylene glycol which is different from the propylene glycol, 1,3-butanediol, TPG and DEG is exemplified, for example, by ethylene glycol, triethylene glycol, dipropylene glycol, thiodiglycol, hexylene glycol, etc. It is allowable that one kind of the humectant as described above is used singly, or two or more kinds of the humectant are used in combination.

It is allowable that the water-soluble organic solvent further contains a penetrant. For example, the penetrant adjusts the drying velocity of the water-based ink on the recording medium.

The penetrant is exemplified, for example, by glycol ether. The glycol ether is exemplified, for example, by ethylene glycol methyl ether, ethylene glycol ethyl ether, ethylene glycol-n-propyl ether, diethylene glycol methyl ether, diethylene glycol ethyl ether, diethylene glycol-n-propyl ether, diethylene glycol-n-butyl ether, diethylene glycol-n-hexyl ether, triethylene glycol methyl ether, triethylene glycol ethyl ether, triethylene glycol-n-propyl ether, triethylene glycol-n-butyl ether, propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, tripropylene glycol-n-butyl ether, etc. Further, it is allowable to also use, as the penetrant, the lower alcohols such as ethyl alcohol, n-propyl alcohol, isopropyl alcohol, etc., a small amount of acetone, etc., which are exemplified as the humectant. These substances may function as both the humectant and the penetrant described above. One kind of the penetrant may be used singly, or two or more kinds of the penetrant may be used in combination.

The content amount of the penetrant in the entire amount of the water-based ink is, for example, in a range of 0% by mass to 20% by mass, in a range of 0% by mass to 15% by mass, or in a range of 1% by mass to 6% by mass.

The water is preferably ion-exchanged water or pure water (purified water). The content amount of the water in the entire amount of the water-based ink is, for example, in a range of 10% by mass to 90% by mass, or in a range of 20% by mass to 80% by mass. The content amount of the water may be, for example, a balance of the other components.

The water-based ink may further contain resin minute particles (resin fine particles). The glass-transition temperature (Tg) of the resin minute particles is, for example, in a range of −60° C. to 150° C., in a range of 20° C. to 100° C., or is not more than 75° C. The resin minute particles may be, for example, resin minute particles contained in a resin emulsion. The term “resin emulsion” means a resin emulsion composed of, for example, the resin minute particle and a disperse medium (for example, water, etc.); in the resin emulsion, the resin minute particles are dispersed with a specific particle diameter (particle size) in the disperse medium, rather than in a dissolved state in the disperse medium. In the present specification, the resin minute particles included in the resin emulsion are defined as “emulsion particles”. A resin composing the resin minute particles may be exemplified, for example, by acrylic acid-based resin, maleate ester-based resin, vinyl acetate-based resin, carbonate-based resin, styrene-based resin, ethylene-based resin, propylene-based resin, urethane-based resin, and copolymer resin thereof. Only one kind of the resin minute particles as described above may be used singly, or two or more kinds of the resin minute particles as described above may be used in combination. Among the resin minute particles as indicated above, resin minute particles composed of the acrylic acid-based resin are preferred.

As the resin emulsion, it is allowable to use, for example, a commercially available product. The commercially available product is exemplified, for example, by “MOWINYL (trade name) 6969D” (acrylic resin emulsion) (Tg: 71° C.), “MOWINYL (trade name) 5450” (Tg: 53° C.) and “MOWINYL (trade name) DM772” (Tg: 22° C.) produced by JAPAN COATING RESIN CO., LTD.; “POLYSOL (trade name) AP-3770 (styrene-acrylic resin emulsion) produced by SHOWA DENKO K.K.; “SUPERFLEX (trade name) 150” (urethane resin emulsion) (Tg: 40° C.) produced by DKS CO., LTD. (DAI-ICHI KOGYO SEIYAKU CO., LTD.); etc.

The mean (average) particle diameter (size) of the resin minute particles is, for example, in a range of 5 nm to 500 nm, in a range of 20 nm to 300 nm or in a range of 30 nm to 200 nm. The mean particle diameter can be measured, for example, by using a dynamic light scattering particle diameter distribution measuring apparatus “LB-550” (product name) produced by HORIBA, LTD., as the arithmetic mean diameter. The mean particle diameter may be a mean particle diameter (intensity mean particle diameter) calculated based on an intensity-based particle size distribution (light scattering intensity-based particle size distribution).

The content amount of the resin minute particles in the entire amount of the water-based ink is, for example, in a range of 0.1% by mass to 30% by mass, in a range of 0.5% by mass to 20% by mass, or in a range of 1% by mass to 10% by mass. One kind of the resin minute particles described above may be used singly, or two or more kinds of the resin minute particles as described above may be used in combination.

The water-based ink may be a chromatic ink containing a colorant, or may be achromatic (colorless) ink not containing any colorant. In the chromatic ink, the colorant may be either one of a pigment and a dye. Further, as the colorant, the pigment and the dye may be mixed and used as the colorant.

The pigment is not particularly limited, and may be exemplified, for example, by carbon black, an inorganic pigment, an organic pigment, etc. The carbon black is exemplified, for example, by furnace black, lamp black, acetylene black, channel black, etc. The inorganic pigment is exemplified, for example, by titanium oxide, iron oxide-based inorganic pigments, carbon black-based inorganic pigments, etc. The organic pigment is exemplified, for example, by azo-pigments such as azo lake, insoluble azo-pigment, condensed azo-pigment, chelate azo-pigment, etc.; polycyclic pigments such as phthalocyanine pigment, perylene and perynon pigments, anthraquinone pigment, quinacridone pigment, dioxadine pigment, thioindigo pigment, isoindolinone pigment, quinophthalone pigment, etc.; dye lake pigments such as basic dye type lake pigment, acid dye type lake pigment, etc.; nitro pigments; nitroso pigments; aniline black daylight fluorescent pigment; etc. Further, it is also allowable to use, as the pigment, any pigment different from those listed above and dispersible in water phase. Specific examples of these pigments include, for example, C. I. Pigment Blacks 1, 6, and 7; C. I. Pigment Yellows 1, 2, 3, 12, 13, 14, 15, 16, 17, 55, 74, 78, 150, 151, 154, 180, 185, and 194; C. Pigment Oranges 31 and 43; C. I. Pigment Reds 2, 3, 5, 6, 7, 12, 15, 16, 48, 48:1, 53:1, 57, 57:1, 112, 122, 123, 139, 144, 146, 149, 150, 166, 168, 175, 176, 177, 178, 184, 185, 190, 202, 209, 221, 222, 224, and 238; C. I. Pigment Violets 19 and 196; C. I. Pigment Blues 1, 2, 3, 15, 15:1, 15:2, 15:3, 15:4, 16, 22, and 60; C. I. Pigment Greens 7 and 36; and solid solutions of the above-listed pigments. The water-based ink related to the present disclosure may be prepared by dispersing the pigment in water with a dispersant. As the dispersant, it is allowable to use, for example, a general polymeric dispersant (resin for dispersing pigment or resin-dispersing pigment, resin dispersant), etc., and may be prepared in-house. Alternatively, in the water-based ink related to the present disclosure, the pigment may be subjected to polymer capsulation.

The pigment may be a self-dispersible pigment. The self-dispersible pigment is dispersible in water without using any dispersant, for example, owing to the fact that at least one of a hydrophilic functional group and the salt thereof including, for example, carbonyl group, hydroxyl group, carboxylic acid group, sulfonic acid group (sulfonate group), phosphoric acid group (phosphate group), etc., is introduced into the surfaces of the particles of the pigment by the chemical bond directly or with any group intervening therebetween. It is possible to use self-dispersible pigments subjected to the surface treatment by any one of methods described, for example, in Japanese Patent Application Laid-open No. HEIR-3498 (corresponding to U.S. Pat. No. 5,609,671), Published Japanese Translation of PCT International Publication for Patent Application No. 2000-513396 (corresponding to U.S. Pat. No. 5,837,045), Published Japanese Translation of PCT International Publication for Patent Application No. 2008-524400 (corresponding to United States Patent Application Publication No. US 2006/0201380 A1), Published Japanese Translation of PCT International Publication for Patent Application No. 2009-515007 (corresponding to United States Patent Application Publications No. US 2007/0100023 A1 and No. US 2007/0100024 A1), Published Japanese Translation of PCT International Publication for Patent Application No. 2011-515535 (corresponding to United States Patent Application Publications No. US 2009/0229489 A1), etc. It is possible to use, as a material for the self-dispersible pigment, either one of the inorganic pigment and the organic pigment. Further, a pigment which is suitable for the above-described treatment includes, for example, carbon black such as “MA8” and “MA100” produced by MITSUBISHI CHEMICAL CORPORATION, etc. As the self-dispersible pigment, it is possible, for example, to use a commercially available product. The commercially available product includes, for example, “CAB-O-JET (trade name) 200”, “CAB-O-JET (trade name) 250C”, “CAB-O-JET (trade name) 260M”, “CAB-O-JET (trade name) 270Y”, “CAB-O-JET (trade name) 300”, “CAB-O-JET (trade name) 400”, “CAB-O-JET (trade name) 450C”, “CAB-O-JET (trade name) 465M” and “CAB-O-JET (trade name) 470Y” produced by CABOT SPECIALTY CHEMICALS; “BONJET (trade name) BLACK CW-2” and “BONJET (trade name) BLACK CW-3” produced by ORIENT CHEMICAL INDUSTRIES, LTD.; “LIOJET (trade name) WD BLACK 002C” produced by TOYO INK MFG. CO., LTD.; etc.

The solid content amount of the pigment (pigment solid content amount) in the entire amount of the water-based ink is not particularly limited, and may be appropriately determined based on, for example, a desired optical density, chromaticness, etc. The pigment solid content amount is, for example, in a range of 0.1% by mass to 20% by mass, in a range of 1% by mass to 15% by mass, or in a range of 2% by mass to 10% by mass.

The dye is not specifically limited, and is exemplified, for example, by a direct dye, an acidic dye, a basic dye, a reactive dye, a food dye, etc. Specific examples of the dye include, for example, C. I. Direct Black, C. I. Direct Blue, C. I. Direct Red, C. I. Direct Yellow, C. I. Direct Orange, C. I. Direct Violet, C. I. Direct Brown, C. I. Direct Green; C. I. Acid Black, C. I. Acid Blue, C. I. Acid Red, C. I. Acid Yellow, C. I. Acid Orange, C. I. Acid Violet; C. I. Basic Black, C. I. Basic Blue, C. I. Basic Red, C. I. Basic Violet; C. I. Reactive Blue, C. I. Reactive Red, C. I. Reactive Yellow; C. I. Food Black, C. I. Food Red, C. I. Food Yellow; etc. C. I. Direct Black described above is exemplified, for example, by C. I. Direct Blacks 17, 19, 22, 31, 32, 51, 62, 71, 74, 108, 112, 113, 146, 154, 168, 195, etc. C. I. Direct Blue described above is exemplified, for example, by C. I. Direct Blues 1, 6, 15, 22, 25, 41, 71, 76, 77, 80, 86, 90, 98, 106, 108, 120, 158, 163, 168, 199, 226, etc. C. I. Direct Red described above is exemplified, for example, by C. I. Direct Reds 1, 2, 4, 9, 11, 17, 20, 23, 24, 28, 31, 39, 46, 62, 75, 79, 80, 83, 89, 95, 197, 201, 218, 220, 224, 225, 226, 227, 228, 229, 230, etc. C. I. Direct Yellow described above is exemplified, for example, by C. I. Direct Yellows 8, 11, 12, 24, 26, 27, 28, 33, 39, 44, 50, 58, 85, 86, 87, 88, 89, 98, 100, 110, 132, 142, 173, etc. C. I. Direct Orange described above is exemplified, for example, by C. I. Direct Oranges 34, 39, 44, 46, 60, etc. C. I. Direct Violet described above is exemplified, for example, by C. I. Direct Violets 47, 48, etc. C. I. Direct Brown described above is exemplified, for example, by C. I. Direct Brown 109, etc. C. I. Direct Green described above is exemplified, for example, by C. I. Direct Green 59, etc. C. I. Acid Black described above is exemplified, for example, by C. I. Acid Blacks 2, 7, 24, 26, 31, 48, 51, 52, 63, 110, 112, 115, 118, 156, etc. C. I. Acid Blue described above is exemplified, for example, by C. I. Acid Blues 1, 7, 9, 15, 22, 23, 25, 29, 40, 43, 59, 62, 74, 78, 80, 90, 93, 100, 102, 104, 117, 120, 127, 138, 158, 161, 167, 220, 234, etc. C. I. Acid Red described above is exemplified, for example, by C. I. Acid Reds 1, 6, 8, 9, 13, 14, 18, 26, 27, 32, 35, 37, 42, 51, 52, 80, 83, 85, 87, 89, 92, 94, 106, 114, 115, 133, 134, 145, 158, 180, 198, 249, 256, 265, 289, 315, 317, etc. C. I. Acid Yellow described above is exemplified, for example, by C. I. Acid Yellows 1, 3, 7, 11, 17, 23, 25, 29, 36, 38, 40, 42, 44, 61, 71, 76, 98, 99, etc. C. I. Acid Orange described above is exemplified, for example, by C. I. Acid Oranges 7, 19, etc. C. I. Acid Violet described above is exemplified, for example, by C. I. Acid Violet 49, etc. The C. I. Basic Black is exemplified, for example, by C. I. Basic Black 2, etc. The C. I. Basic Blue is exemplified, for example, by C. I. Basic Blues 1, 3, 5, 7, 9, 24, 25, 26, 28, 29, etc. The C. I. Basic Red is exemplified, for example, by C. I. Basic Reds 1, 2, 9, 12, 13, 14, 37, etc. The C. I. Basic Violet is exemplified, for example, by C. I. Basic Violets 7, 14, 27, etc. C. I. Reactive Blue described above is exemplified, for example, by C. I. Reactive Blues 4, 5, 7, 13, 14, 15, 18, 19, 21, 26, 27, 29, 32, 38, 40, 44, 100, etc. C. I. Reactive Red described above is exemplified, for example, by C. I. Reactive Reds 7, 12, 13, 15, 17, 20, 23, 24, 31, 42, 45, 46, 59, etc. C. I. Reactive Yellow described above is exemplified, for example, by C. I. Reactive Yellows 2, 3, 17, 25, 37, 42, etc. C. I. Food Black described above is exemplified, for example, by C. I. Food Blacks 1, 2, etc. C. I. Food Red described above is exemplified, for example, by C. I. Food Reds 87, 92, 94, etc. C. I. Food Yellow described above is exemplified, for example, by C. I. Food Yellow 3, etc.

It is allowable that one kind of the dye as described above is used singly, or two or more kinds of the dye are used in combination. The content amount of the dye in the entire amount of the water-based ink is, for example, in a range of 0.1% by mass to 20% by mass, in a range of 1% by mass to 15% by mass, or in a range of 2% by mass to 10% by mass.

The water-based ink may further include a conventionally known additive, as necessary. The additive is exemplified, for example, by pH-adjusting agents, viscosity-adjusting agents, surface tension-adjusting agents, fungicides, etc. The viscosity-adjusting agents are exemplified, for example, by polyvinyl alcohol, cellulose, water-soluble resin, etc.

The water-based ink can be prepared, for example, by uniformly mixing the surfactant, the water-soluble organic solvent, the water, and an optionally other additive(s) as necessary, by a conventionally known method, and then removing any non-dissolved matter, with a filter, etc.

Next, an ink-jet recording apparatus and an ink-jet recording method related to the present disclosure will be explained.

The ink-jet recording apparatus related to the present disclosure is an ink-jet recording apparatus characterized by including: an ink storing part (ink storage), and an ink discharging mechanism (ink-jet head); and being configured to discharge an ink stored in the ink storing part by the ink discharging mechanism; wherein the water-based ink for ink-jet recording related to the present disclosure is stored in the ink storing part. As will be described later on, the ink-jet recording apparatus related to the present disclosure may further include a drying mechanism configured to dry a recording part or recording portion recorded by using the ink.

The ink-jet recording method related to the present disclosure is characterized by including: a recording step of performing recording by jetting (by discharging) a water-based ink onto a recording medium in accordance with an ink-jet system; wherein the water-based ink for ink-jet recording related to the present disclosure is used as the water-based ink in the recording step. The ink jet recording method related to the present disclosure may further include a fixing step of fixing the water-based ink to the recording medium by use of a drying mechanism configured to dry a recording part of the recording medium.

The ink-jet recording method related to the present disclosure can be performed, for example, by using the ink-jet recording apparatus related to the present disclosure. The recording includes printing a letter (text), printing an image, printing, etc.

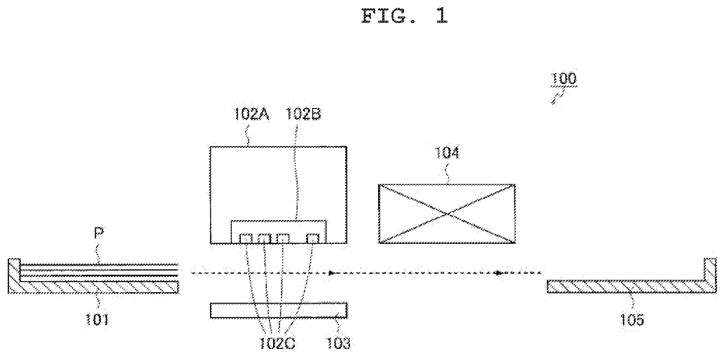

FIG. 1 schematically depicts an exemplary configuration of the ink-jet recording apparatus related to the present disclosure. As depicted in FIG. 1, an ink-jet recording apparatus 100 includes a feed tray 101, a conveyance mechanism (not depicted) such as a roller, recording mechanisms 102A and 102B, a platen 103, a drying mechanism 104, a discharge tray 105, and ink storing sections (not depicted) such as ink cartridges or ink tanks. The feed tray 101 can support a plurality of pieces of a recording medium P (e.g., a plurality of pieces of coated paper sheet) stacked thereon.

The recording mechanism includes a carriage 102A and an ink-jet head (ink jetting mechanism) 102B. The carriage 102A is supported by two guide rails (not depicted) extending orthogonally with respect to a conveyance direction of the recording medium P. The two guide rails are supported by a casing (not depicted) of the ink jet recording apparatus 100. The carriage 102A is connected to a well-known belt mechanism (not depicted) provided in the two guide rails. The belt mechanism is driven by a carriage motor (not depicted). The carriage motor is driven to thereby cause the carriage 102A connected to the belt mechanism to reciprocate (move reciprocatingly) in an orthogonal direction which is orthogonal with respect to the conveyance direction of the recording medium P.

Further, four ink tubes (not depicted) connecting the ink storing sections and the ink-jet head 102B, and a flexible flat cable (not depicted) electrically connecting a control board (not depicted) and the ink-jet head 102B extend from the carriage 102A. Four colors of water-based inks (yellow, magenta, cyan, and black) stored in the ink storing sections are supplied to the ink-jet head 102B via the four ink tubes. At least one of the four water-based inks is the water-based ink for ink-jet recording related to the present disclosure. A control signal outputted from the control board is transmitted to the ink-jet head 102B via the flexible flat cable.

As depicted in FIG. 1, the carriage 102A has the ink-jet head 102B mounted or installed therein. Nozzles 102C are formed in a lower surface of the ink jet head 102B. A front end of each of the nozzles 102C is exposed from the carriage 102A and the lower surface of the ink-jet head 102B. The ink-jet head 102B includes an actuator (not depicted) which applies force for jetting the water-based ink which is supplied from the ink storing section to the ink-jet head 102B via the ink tube. The actuator may be an actuator of any system, such as a piezoelectric element system, a thermal ink-jet system, an electrostatic attraction system, etc. The ink-jet head 102B jets or discharges the water-based ink, as fine or minute ink droplets of the water-based ink, from the nozzles 102C during a process in which the carriage 102A reciprocates in the orthogonal direction with respect to the conveyance direction of the recording medium P. With this, an image is recorded on the recording medium P. The platen 103 is arranged so as to face the recording mechanism, and supports the recording medium P conveyed from the feed tray 101.

The drying mechanism 104 heats and dries a recording part of the recording medium P. The drying temperature during the drying can be adjusted as appropriate by changing the setting of the drying mechanism 104. Specifically, the drying temperature may be, for example, in a range of 20° C. to 200° C. or in a range of 50° C. to 100° C. The drying time may be also adjusted as appropriate by changing the setting of the drying mechanism 104. For example, the drying time may be in a range of a second(s) exceeding 0 seconds to not more than 300 seconds, in a range of 0.1 seconds to 60 seconds, or in a range of 1 second to 60 seconds. Any drying mechanism which is capable of drying the recording part may be used as the drying mechanism 104. Examples of the drying mechanism 104 include heating mechanisms such as commercially available dryers, IR heaters, ovens, belt conveyer ovens, irons, hot presses, etc. A non-contact drying mechanism, such as the drier, the IR heater, the oven, the belt conveyer oven, etc., which dries the recording part of the recording medium P without contacting with the recording part is preferably used.

The recording medium P after recording and drying is conveyed to the discharge tray 105.

### EXAMPLES

Next, Examples of the present disclosure are explained together with Comparative Examples. Note that the present disclosure is not limited to and restricted by Examples and Comparative Examples described below.

<Preparation of Resin Dispersant>

135 g of Terathane (trade name) 650 (polyether diol produced by INVISTA (Wichita, Kans.)), 54 g of 2,2′-dimethylolpropionic acid (DMPA), 132 g of sulfolane and 0.06 g of dibutyltin dilaurate (DBTDL) were added to a flask provided with a dropping funnel, a condenser and an agitator (stirring device) under an atmosphere of nitrogen, then were heated up to 60° C. while being mixed, and then were mixed sufficiently; thus, a mixture was obtained. To the obtained mixture, 164 g of m-tetramethylene xylylenediisocyanate (TMXDI) was added with the dropping funnel, and remaining TMXDI in the dropping funnel was rinsed with 15 g of sulfolane into the flask. The temperature was raised up to 100° C., and was maintained at 100° C. until the content rate of isocyanate reached to be not more than 1.3% by mass. Next, the temperature was lowered up to 60° C., then 12.9 g of diethanolamine (DEA) was added to the mixture over 5 (five) minutes with the dropping funnel, and the temperature was maintained at 60° C. until remaining DEA in the dropping funnel was rinsed with 5 g of sulfolane into the flask. Furthermore, the temperature was maintained at 60° C. for one hour, then 376 g of a 3% by mass aqueous solution of potassium hydroxide was added to the mixture over 10 (ten) minutes with the dropping funnel, then 570 g of deionized water was further added to the mixture. Then, the temperature was maintained at 60° C. for one hour, and cooling to the room temperature was performed. Thus, a resin dispersant with 24% by mass of solid content was obtained.

<Preparation of Pigment Dispersion Liquid A>

The resin dispersant was neutralized with either one of potassium hydroxide and amine in order to increase the solubility in water and to make the resin dispersant to easily dissolve to water. Then, a microfluidizer of high-pressure compressed air system (Model name: M-110Y, produced by MICROFLUIDICS (Newton, Mass.)) was used so as to produce a mixture in which content amount of carbon black was approximately 27% by mass and the mass ratio (P/D) of the content amount (P) of the carbon black to the content amount (D) of the resin dispersant was P/D=3. Then, deionized water was added to the mixture so that the content amount of the carbon black was made to be approximately 24% by mass for the suitable medium mill grinding condition; and the mixture was milled (pulverized) for 4 (four) hours. After the milling, the deionized water was added, and the mixture was mixed sufficiently. Then, after any impurity was filtered and removed, dilution with deionized water was performed so that the content amount of the carbon black was made to be 15% by mass; thus, a pigment dispersion liquid A was obtained.

<Preparation of Pigment Dispersion Liquid B>

A pigment dispersion Liquid B was obtained similarly to the above-described preparation of the pigment dispersion liquid A, except that an Eiger Minimill (Model name: M250, produced by VSE EXP, EIGER MACHINERY INC. (Chicago, Ill.)) was used, instead of using the microfluidizer of high-pressure compressed air system, and that a phthalocyanine pigment was used instead of using the carbon black.

### Examples 1 to 6 and 8 to 11, and Comparative Examples 1 to 6

Ingredients or components, except for the resin minute particles (resin emulsion) and the pigment dispersion liquids A and B, which were included in Water-based ink composition (TABLE 1 or TABLE 2) were mixed uniformly or homogeneously; and thus an ink solvent was obtained. Subsequently, the resin emulsion was added to the ink solvent, followed by being mixed uniformly, and then the pigment dispersion liquid A or B was added to the ink solvent in which the resin emulsion had been mixed, followed by being mixed uniformly, and thus a mixture was obtained. After that, the obtained mixture was filtrated through a cellulose acetate membrane filter (pore size 3.00 μm) produced by TOYO ROSHI KAISHA, LTD., and thus the water-based ink for ink-jet recording of each of Examples 1 to 6 and 8 to 11 as indicated in TABLE 1, and Comparative examples 1 to 6 as indicated in TABLE 2 was obtained.

### Example 7

Ingredients or components, except for the resin minute particles (resin emulsion) and C.I. Acid Red (azo dye), which were included in Water-based ink composition (TABLE 1) were mixed uniformly or homogeneously; and thus an ink solvent was obtained. Subsequently, the resin emulsion was added to the ink solvent, followed by being mixed uniformly, and then the C.I. Acid Red 52 was added to the ink solvent in which the resin emulsion had been mixed, followed by being mixed uniformly, and thus a mixture was obtained. After that, the obtained mixture was filtrated through a cellulose acetate membrane filter (pore size 3.00 μm) produced by TOYO ROSHI KAISHA, LTD., and thus the water-based ink for ink-jet recording of Example 7 as indicated in TABLE 1 was obtained. The water-based ink of Example 7 is an ink which used a dye as the colorant.

### Example 12

Ingredients or components, except for the resin minute particles (resin emulsion), which were included in Water-based ink composition (TABLE 1) were mixed uniformly or homogeneously; and thus an ink solvent was obtained. Subsequently, the resin emulsion was added to the ink solvent, followed by being mixed uniformly, and thus a mixture was obtained. After that, the obtained mixture was filtrated through a cellulose acetate membrane filter (pore size 3.00 μm) produced by TOYO ROSHI KAISHA, LTD., and thus the water-based ink for ink-jet recording of Example 12 as indicated in TABLE 1 was obtained. The water-based ink of Example 12 is a colorless or achromatic ink (clear ink) not including any colorant.

With respect to the water-based inks of Examples 1 to 12 and Comparative examples 1 to 6, (a) evaluation of surfactant dissolution, (b) evaluation of spreading of ink droplet, (c) evaluation of fixing property to paper sheet, and (d) evaluation of fixing property to film were conducted by the following methods.

(a) Evaluation of Surfactant Dissolution

The filtration filter after the preparation of the water-based ink of each of Examples 1 to 12 and Comparative Examples 1 to 6 was visually observed, and evaluation was made based on the following evaluation criterion.

<Evaluation of Surfactant Dissolution: Evaluation Criterion>

G: Any residual of undissolved matter and/or aggregate were/was not present.

NG: A residual of undissolved matter and/or aggregate were/was present.

(b) Evaluation of Spreading of Ink Droplet

An ink-jet printer MFC-J4225N, produced by BROTHER KOGYO KABUSHIKI KAISHA, was used so as to record an image with the water-based ink of each of Examples 1 to 12 and Comparative Examples 1 to 6 on coated paper (product name: OK Top Coat Plus, produced by OJI PAPER CO., LTD.), at 600 dpi, while changing an ink amount per 1 (one) dot (8 pL to 10 pL/dot or 12 pL to 14 pL/dot). The image was visually observed, and the evaluation was made based on the following evaluation criterion.

<Evaluation of Spreading of Ink Droplet: Evaluation Criterion>

AA: There was not any gap between the dots in an image recorded by 8 pL to 10 pL/dot.

A: Although there was a gap between the dots in an image recorded by 8 pL to 10 pL/dot, there was not any gap between the dots in an image recorded by 12 pL to 14 pL/dot.

B: There was a gap between the dots in an image recorded by 12 pL to 14 pL/dot.

(c) Evaluation of Fixing Property to Paper Sheet

The above-described ink-jet printer MFC-J4225N was used to record an image on coated paper (product name: OK Top Coat Plus, produced by OJI PAPER CO., LTD.) with each of the water-based inks of Examples 1 to 12 and Comparative Examples 1 to 6, at 600 dpi and in an ink amount in a range of 8 pL to 10 pL/dot, and thus a recorded matter was obtained. Afterwards, the recorded matter was dried for 1 (one) minute under an atmosphere of 100° C., and then was cooled down to the room temperature (approximately 20° C.). After the cooling, a cotton swab to which a pressure of 0.2 MPa or 0.1 MPa was being applied was moved on a surface of the image at a velocity of approximately 50 mm/second; the fixing property of the water-based ink to the paper was visually observed, and the evaluation was made based on the following evaluation criterion.

<Evaluation of Fixing Property to Paper Sheet: Evaluation Criterion>

AA: Even under the pressure of 0.2 MPa, the water-based ink was not adhered to the cotton swab, and was fixed to the paper sheet.

A: Under the pressure of 0.2 MPa, a small amount of the water-based ink was adhered to the cotton swab. However, under the pressure of 0.1 MPa, the water-based ink was not adhered to the cotton swab, and was fixed to the paper sheet.

B: Under the pressure of 0.1 MPa, a small amount of the water-based ink was adhered to the cotton swab.

(d) Evaluation of Fixing Property to Film

The fixing property to film was visually observed in a similar manner as in (c) Evaluation of fixing property to paper sheet as described above, except that a commercially available PET (polyethylene terephthalate) film was used instead of using the coat paper (OK Top Coat Plus, produced by OJI PAPER CO., LTD.); and the evaluation was made based on the following evaluation criterion.

<Evaluation of Fixing Property to Film: Evaluation Criterion>

AA: Even under the pressure of 0.2 MPa, the water-based ink was not adhered to the cotton swab, and was fixed to the film.

A: Under the pressure of 0.2 MPa, a small amount of the water-based ink was adhered to the cotton swab. However, under the pressure of 0.1 MPa, the water-based ink was not adhered to the cotton swab, and was fixed to the film.

B: Under the pressure of 0.1 MPa, a small amount of the water-based ink was adhered to the cotton swab.

The water-based ink compositions and the evaluation results of the above-described evaluations (a) to (d) in Examples 1 to 12 and Comparative Examples 1 to 6 are indicated in TABLE 1 and TABLE 2 as follows.

TABLE 1

| | | | Examples | | | |
|---|---|---|---|---|---|---|
| | | | 1 | 2 | 3 | 4 |
| Water-based | Surfactant | OLFINE (trade name) | 2.00 | — | — | — |
| ink composition | | El004 (*1) | | | | |
| (% by mass) | | SURFYNOL (trade name) | — | 2.00 | — | — |
| | | 440 (*2) | | | | |
| | | EMULGEN (trade name) | — | — | 2.00 | — |
| | | 106 (*3) | | | | |
| | | EMULGEN (trade name) | — | — | — | 2.00 |
| | | 705 (*4) | | | | |
| | | NONION P-210 (*5) | — | — | — | — |
| | | ACETYLENOL (trade | — | — | — | — |
| | | name) E40 (*6) | | | | |
| | Humectant | Propylene glycol | 30.00 | 30.00 | 30.00 | 30.00 |
| | | 1,3-butanediol | — | — | — | — |
| | | TPG | 3.00 | 3.00 | 3.00 | 3.00 |
| | | DEG | — | — | — | — |
| | Penetrant | Triethylene glycol-n-butyl | — | — | — | — |
| | | ether | | | | |
| | | Tripropylene glycol-n- | — | — | — | — |
| | | butyl ether | | | | |
| | Resin minute | MOWINYL (trade name) | 5.00 | 5.00 | 5.00 | 5.00 |
| | particles | 6969D (*7) | | | | |
| | | POLYSOL (trade name) | — | — | — | — |
| | | AP-3770 (*8) | | | | |
| | Colorant | Pigment dispersion liquid | 3.90 | 3.90 | 3.90 | 3.90 |
| | | A (*9) | 1.30 | 1.30 | 1.30 | 1.30 |
| | | Pigment dispersion liquid | — | — | — | — |
| | | B (*10) | — | — | — | — |
| | | C.I. Acid Red 52 | — | — | — | — |
| | Water | | balance | balance | balance | balance |
| (a) Surfactant dissolution | | | G | G | G | G |
| (b) Spreading of ink droplet | | | AA | AA | AA | AA |
| (c) Fixing property to paper sheet | | | AA | AA | AA | AA |
| (d) Fixing property to film | | | A | A | A | A |
| | | | Examples | | | |
| | | | 5 | 6 | 7 | 8 |
| Water-based | Surfactant | OLFINE (trade name) | — | — | 2.00 | — |
| ink composition | | E1004 (*1) | | | | |
| (% by mass) | | SURFYNOL (trade name) | — | — | — | — |
| | | 440 (*2) | | | | |
| | | EMULGEN (trade name) | — | — | — | 2.00 |
| | | 106 (*3) | | | | |
| | | EMULGEN (trade name) | — | — | — | — |
| | | 705 (*4) | | | | |
| | | NONION P-210 (*5) | 2.00 | — | — | — |
| | | ACETYLENOL (trade | — | 2.00 | — | — |
| | | name) E40 (*6) | | | | |
| | Humectant | Propylene glycol | 30.00 | 30.00 | 30.00 | 20.00 |
| | | 1,3-butanediol | — | — | — | 10.00 |
| | | TPG | 3.00 | 3.00 | 3.00 | — |
| | | DEG | — | — | — | 3.00 |
| | Penetrant | Triethylene glycol-n-butyl | — | — | — | — |
| | | ether | | | | |
| | | Tripropylene glycol-n- | — | — | — | — |
| | | butyl ether | | | | |
| | Resin minute | MOWINYL (trade name) | 5.00 | 5.00 | 4.00 | — |
| | particles | 6969D (*7) | | | | |
| | | POLYSOL (trade name) | — | — | — | 4.00 |
| | | AP-3770 (*8) | | | | |
| | Colorant | Pigment dispersion liquid | 3.90 | 3.90 | — | — |
| | | A (*9) | 1.30 | 1.30 | — | — |
| | | Pigment dispersion liquid | — | — | — | 3.00 |
| | | B (*10) | — | — | — | 1.00 |
| | | C.I. Acid Red 52 | — | — | 2.40 | — |
| | Water | | balance | balance | balance | balance |
| (a) Surfactant dissolution | | | G | G | G | G |
| (b) Spreading of ink droplet | | | AA | AA | AA | AA |
| (c) Fixing property to paper sheet | | | AA | AA | AA | AA |
| (d) Fixing property to film | | | A | A | A | A |
| | | | Examples | | | |
| | | | 9 | 10 | 11 | 12 |
| Water-based | Surfactant | OLFINE (trade name) | 2.70 | 1.20 | 1.00 | 1.50 |
| ink composition | | E1004 (*1) | | | | |
| (% by mass) | | SURFYNOL (trade name) | — | — | — | — |
| | | 440 (*2) | | | | |
| | | EMULGEN (trade name) | — | — | 1.00 | — |
| | | 106 (*3) | | | | |
| | | EMULGEN (trade name) | — | — | — | — |
| | | 705 (*4) | | | | |
| | | NONION P-210 (*5) | — | — | — | — |
| | | ACETYLENOL (trade | — | — | — | — |
| | | name) E40 (*6) | | | | |
| | Humectant | Propylene glycol | 20.00 | 10.00 | — | 30.00 |
| | | 1,3-butanediol | 10.00 | 20.00 | 30.00 | 10.00 |
| | | TPG | 3.00 | — | — | 5.00 |
| | | DEG | — | — | 2.00 | — |
| | Penetrant | Triethylene glycol-n-butyl | — | 2.00 | — | 1.00 |
| | | ether | | | | |
| | | Tripropylene glycol-n- | — | 1.00 | 1.00 | — |
| | | butyl ether | | | | |
| | Resin minute | MOWINYL (trade name) | — | — | 5.00 | 8.00 |
| | particles | 6969D (*7) | | | | |
| | | POLYSOL (trade name) | 4.00 | 3.00 | — | — |
| | | AP-3770 (*8) | | | | |
| | Colorant | Pigment dispersion liquid | — | — | 4.50 | — |
| | | A (*9) | — | — | 1.50 | — |
| | | Pigment dispersion liquid | 3.90 | 2.40 | — | — |
| | | B (*10) | 1.30 | 0.80 | — | — |
| | | C.I. Acid Red 52 | — | — | — | — |

| | | | | |
|---|---|---|---|---|
| Water | balance | balance | balance | balance |

| | | | | |
|---|---|---|---|---|
| (a) Surfactant dissolution | G | G | G | G |
| (b) Spreading of ink droplet | AA | A | AA | AA |
| (c) Fixing property to paper sheet | A | A | AA | AA |
| (d) Fixing property to film | A | A | A | A |

TABLE 1 - LEGEND
(*1): Surfactant having solubility in water at 20° C. in a range of 0.05% by mass to 0.2% by mass; produced by NISSHIN CHEMICAL CO.; the numeral in TABLE 1 indicates the active ingredient amount;
(*2): Surfactant having solubility in water at 20° C. in a range of 0.05% by mass to 0.2% by mass; produced by NISSHIN CHEMICAL CO.; the numeral in TABLE 1 indicates the active ingredient amount;
(*3): Surfactant having solubility in water at 20° C. in a range of 0.05% by mass to 0.2% by mass; produced by KAO CORPORATION; the numeral in TABLE 1 indicates the active ingredient amount;
(*4): Surfactant having solubility in water at 20° C. in a range of 0.05% by mass to 0.2% by mass; produced by KAO CORPORATION; the numeral in TABLE 1 indicates the active ingredient amount;
(*5): Surfactant having solubility in water at 20° C. in a range of 0.05% by mass to 0.2% by mass; produced by NOF CORPORATION; the numeral in TABLE 1 indicates the active ingredient amount;
(*6): Surfactant having solubility in water at 20° C. in a range of 0.05% by mass to 0.2% by mass; produced by KAWAKEN FINE CHEMICALS CO., LTD.; the numeral in TABLE 1 indicates the active ingredient amount;
(*7): Resin emulsion produced by JAPAN COATING RESIN CORPORATION; the numeral in TABLE 1 indicates the active ingredient amount (solid content amount);
(*8): Resin emulsion produced by SHOWA DENKO K.K.; the numeral in TABLE 1 indicates the active ingredient amount (solid content amount);
(*9): Carbon black dispersion liquid; the numeral in upper column indicates the pigment solid content amount, and the numeral in lower column indicates the blending amount of the resin dispersant; and
(*10): Phthalocyanine pigment dispersion liquid; the numeral in upper column indicates the pigment solid content amount, and the numeral in lower column indicates the blending amount of the resin dispersant.

TABLE 2

| | | | Comparative Examples | | |
|---|---|---|---|---|---|
| | | | 1 | 2 | 3 |
| Water-based | Surfactant | OLFINE (trade name) | — | — | — |
| ink composition | | E1004 (*1) | | | |
| (% by mass) | | EMULGEN (trade name) | — | — | — |
| | | 106 (*3) | | | |
| | | OLFINE (trade name) | 2.00 | 4.00 | — |
| | | E1010 (*11) | | | |
| | | EMULGEN (trade name) | — | — | 4.00 |
| | | 108 (*12) | | | |
| | | EMULGEN (trade name) | — | — | — |
| | | 105 (*13) | | | |
| | Humectant | Propylene glycol | 30.00 | 30.00 | 30.00 |
| | | 1,3-butanediol | — | — | — |
| | | TPG | 3.00 | 3.00 | 3.00 |
| | | DEG | — | — | — |
| | Penetrant | Triethylene glycol-n-butyl | — | — | — |
| | | ether | | | |
| | | Tripropylene glycol-n- | — | — | — |
| | | butyl ether | | | |
| | Resin minute | MOWINYL (trade name) | 5.00 | 5.00 | 5.00 |
| | particles | 6969D (*7) | | | |
| | | POLYSOL (trade name) | — | — | — |
| | | AP-3770 (*8) | | | |
| | Colorant | Pigment dispersion liquid | 3.90 | 3.90 | 3.90 |
| | | A (*9) | 1.30 | 1.30 | 1.30 |
| | | Pigment dispersion liquid | — | — | — |
| | | B (*10) | — | — | — |
| | Water | | balance | balance | balance |
| (a) Surfactant dissolution | | | G | G | G |
| (b) Spreading of ink droplet | | | B | A | A |
| (c) Fixing property to paper sheet | | | A | B | B |
| (d) Fixing property to film | | | B | B | B |
| | | | Comparative Examples | | |
| | | | 4 | 5 | 6 |
| Water-based | Surfactant | OLFINE (trade name) | — | — | 0.80 |
| ink composition | | E1004 (*l) | | | |
| (% by mass) | | EMULGEN (trade name) | — | 0.80 | — |
| | | 106 (*3) | | | |
| | | OLFINE (trade name) | — | — | — |
| | | E1010 (*11) | | | |
| | | EMULGEN (trade name) | — | — | — |
| | | 108 (*12) | | | |
| | | EMULGEN (trade name) | 1.00 | — | — |
| | | 105 (*13) | | | |
| | Humectant | Propylene glycol | 30.00 | 10.00 | 10.00 |
| | | 1,3-butanediol | — | 20.00 | 20.00 |
| | | TPG | 3.00 | — | — |
| | | DEG | — | 3.00 | — |
| | Penetrant | Triethylene glycol-n-butyl | — | — | 2.00 |
| | | ether | | | |
| | | Tripropylene glycol-n- | — | — | 1.00 |
| | | butylether | | | |
| | Resin minute | MOWINYL (trade name) | 5.00 | — | — |
| | particles | 6969D (*7) | | | |
| | | POLYSOL (trade name) | — | 4.00 | 3.0 |
| | | AP-3770 (*8) | | | |
| | Colorant | Pigment dispersion liquid | 3.90 | — | — |
| | | A (*9) | 1.30 | — | — |
| | | Pigment dispersion liquid | — | 3.00 | 2.40 |
| | | B (*10) | — | 1.00 | 0.80 |

| | | | |
|---|---|---|---|
| Water | balance | balance | balance |

| | | | |
|---|---|---|---|
| (a) Surfactant dissolution | NG | G | G |
| (b) Spreading of ink droplet | N/A | B | B |
| (c) Fixing property to paper sheet | N/A | A | A |
| (d) Fixing property to film | N/A | B | B |

TABLE 2 - LEGEND
(*1): Surfactant having solubility in water at 20° C. in a range of 0.05% by mass to 0.2% by mass; produced by NISSHIN CHEMICAL CO.; the numeral in TABLE 2 indicates the active ingredient amount;
(*3): Surfactant having solubility in water at 20° C. in a range of 0.05% by mass to 0.2% by mass; produced by KAO CORPORATION; the numeral in TABLE 2 indicates the active ingredient amount;
(*11): Surfactant having solubility in water at 20° C. exceeding 0.2% by mass; produced by NISSHIN CHEMICAL CO.; the numeral in TABLE 2 indicates the active ingredient amount;
(*12): Surfactant having solubility in water at 20° C. exceeding 0.2% by mass; produced by KAO CORPORATION; the numeral in TABLE 2 indicates the active ingredient amount;
(*13): Surfactant having solubility in water at 20° C. less than 0.05% by mass; produced by KAO CORPORATION; the numeral in TABLE 2 indicates the active ingredient amount;
(*7): Resin emulsion produced by JAPAN COATING RESIN CORPORATION; the numeral in TABLE 2 indicates the active ingredient amount (solid content amount);
(*8): Resin emulsion produced by SHOWA DENKO K.K.; the numeral in TABLE 2 indicates the active ingredient amount (solid content amount);
(*9): Carbon black dispersion liquid; the numeral in upper column indicates the pigment solid content amount, and the numeral in lower column indicates the blending amount of the resin dispersant; and
(*10): Phthalocyanine pigment dispersion liquid; the numeral in upper column indicates the pigment solid content amount, and the numeral in lower column indicates the blending amount of the resin dispersant.
Note that in TABLE 2, “N/A” indicates “Not Available”.

As indicated in TABLE 1, in Examples 1 to 12, the evaluation results were satisfactory in relation to all of (a) evaluation of surfactant dissolution, (b) evaluation of spreading of ink droplet, (c) evaluation of fixing property to paper sheet, and (d) evaluation of fixing property to film. In particular, in Examples 1 to 8, 11 and 12 in each of which the content amount of the hydrophobic surfactant in the entire amount of the water-based ink was in the range of 1.3% by mass to 2.5% by mass, the evaluation results were particularly satisfactory in relation to (b) evaluation of spreading of ink droplet and (c) evaluation of fixing property to paper sheet.

On the other hand, as indicated in TABLE 2, Comparative Examples 1 to 3 each using the surfactant having the solubility in water at 20° C. exceeding 0.2% by mass, instead of using the surfactant having the solubility in water at 20° C. in the range of 0.05% by mass to 0.2% by mass, had unsatisfactory results in any one of (b) evaluation of spreading of ink droplet, (c) evaluation of fixing property to paper sheet, and (d) evaluation of fixing property to film. Further, as indicated in TABLE 2, Comparative Example 4 using the surfactant having the solubility in water at 20° C. less than 0.05% by mass, instead of using the surfactant having the solubility in water at 20° C. in the range of 0.05% by mass to 0.2% by mass, had unsatisfactory results in (a) evaluation of surfactant dissolution, was not capable of performing the recording, and thus it was not possible to perform (b) evaluation of spreading of ink droplet, (c) evaluation of fixing property to paper sheet, and (d) evaluation of fixing property to film. Furthermore, as indicated in TABLE 2, Comparative Examples 5 and 6, in each of which the content amount of the surfactant having the solubility in water at 20° C. in the range of 0.05% by mass to 0.2% by mass was less than 1% by mass, had unsatisfactory results in (b) evaluation of spreading of ink droplet and (d) evaluation of fixing property to film.

Parts or all of the embodiment and Examples described above can be also described as in the following addenda. However, the present disclosure is not limited to the following addenda.

(Addendum 1) A water-based ink for ink jet recording, including:

a water-soluble organic solvent;

water; and

a surfactant having solubility in the water at 20° C. in a range of 0.05% by mass to 0.2% by mass, a content amount of the surfactant in an entire amount of the water-based ink being not less than 1% by mass.

(Addendum 2) A water-based ink for ink-jet recording, including:

water;

resin minute particles;

a water-soluble organic solvent including propylene glycol, a content amount of the water-soluble organic solvent in an entire amount of the water-based ink being not less than 20% by mass; and

a surfactant including an acetylene glycol-based surfactant, and having solubility in the water at 20° C. in a range of 0.05% by mass to 0.2% by mass, a content amount of the surfactant in the entire amount of the water-based ink being not less than 1% by mass.

(Addendum 3) A water-based ink for ink-jet recording, including:

water;

resin minute particles;

a water-soluble organic solvent including 1,3-buthanediol, a content amount of the water-soluble organic solvent in an entire amount of the water-based ink being not less than 20% by mass; and

a surfactant including an acetylene glycol-based surfactant, and having solubility in the water at 20° C. in a range of 0.05% by mass to 0.2% by mass, a content amount of the surfactant in the entire amount of the water-based ink being not less than 1% by mass.

(Addendum 4) A water-based ink for ink-jet recording, including:

water;

resin minute particles;

a water-soluble organic solvent including propylene glycol, a content amount of the water-soluble organic solvent in an entire amount of the water-based ink being not less than 20% by mass; and

a surfactant including a polyoxyethylene-based surfactant, and having solubility in the water at 20° C. in a range of 0.05% by mass to 0.2% by mass, a content amount of the surfactant in the entire amount of the water-based ink being not less than 1% by mass.

(Addendum 5) A water-based ink for ink-jet recording, including:

water;

resin minute particles;

a water-soluble organic solvent including 1,3-butanediol, a content amount of the surfactant in an entire amount of the water-based ink being not less than 20% by mass; and

a surfactant including a polyoxyethylene-based surfactant, and having solubility in the water at 20° C. in a range of 0.05% by mass to 0.2% by mass, a content amount of the surfactant in the entire amount of the water-based ink being not less than 1% by mass.

(Addendum 6) An ink-jet recording apparatus including:

an ink storing part (ink storage) storing the water-based ink for ink-jet recording as described in any one of Addenda 1 to 5; and an ink discharging mechanism (ink-jet head) configured to discharge the ink stored in the ink storing part.

(Addendum 7) The ink-jet recording apparatus according to Addendum 6, further including a drying mechanism configured to dry a recording part recorded by the ink.

(Addendum 8) An ink-jet recording method including discharging the water-based ink as described in any one of Addenda 1 to 5 by an ink-jet system onto a recording medium.

(Addendum 9) The ink-jet recording method according to Addendum 8, further including fixing the water-based ink to the recording medium by using a drying mechanism configured to dry a recording part of the recording medium.

As described above, the water-based ink related to the present disclosure has a satisfactory wettability with respect to a hydrophobic recording medium, the ink droplet of the water-based ink spreads on a surface of the hydrophobic recording medium, and a small amount of the water-based ink is capable of filling a predetermined area of the hydrophobic recording medium. The usage of the water-based ink related to the present disclosure is not particularly limited to the ink-jet recording on the hydrophobic recording medium such as the coated paper, etc., and is widely applicable to the ink-jet recording on a variety of kinds of recording medium including, for example, plain paper (regular paper), glossy paper, mat paper, etc.

What is claimed is:

1. A water-based ink for ink-jet recording, comprising:
a water-soluble organic solvent;
water; and
a surfactant having solubility in the water at 20° C. in a range of 0.05% by mass to 0.2% by mass, a content amount of the surfactant in an entire amount of the water-based ink being not less than 1% by mass.

2. The water-based ink for ink-jet recording according to claim 1, wherein the surfactant includes at least one of an acetylene glycol-based surfactant and a polyoxyethylene-based surfactant.

3. The water-based ink for ink-jet recording according to claim 1, wherein the water-soluble organic solvent includes at least one selected from the group consisting of: propylene glycol, 1,3-butanediol, tripropylene glycol and diethylene glycol.

4. The water-based ink for ink-jet recording according to claim 1, wherein a content amount of the water-soluble organic solvent in the entire amount of the water-based ink is not less than 10% by mass.

5. The water-based ink for ink-jet recording according to claim 4, wherein the content amount of the water-soluble organic solvent in the entire amount of the water-based ink is not less than 20% by mass.

6. The water-based ink for ink-jet recording according to claim 4, wherein the content amount of the water-soluble organic solvent in the entire amount of the water-based ink is in a range of 20% by mass to 40% by mass.

7. The water-based ink for ink-jet recording according to claim 1, wherein the content amount of the surfactant in the entire amount of the water-based ink is in a range of 1% by mass to 5% by mass.

8. The water-based ink for ink-jet recording according to claim 7, wherein the content amount of the surfactant in the entire amount of the water-based ink is in a range of 1.2% by mass to 2.7% by mass.

9. The water-based ink for ink-jet recording according to claim 7, wherein the content amount of the surfactant in the entire amount of the water-based ink is in a range of 1.3% by mass to 2.5% by mass.

10. The water-based ink for ink jet recording according to claim 1, further comprising resin minute particles.

11. The water-based ink for ink-jet recording according to claim 10, wherein the resin minute particles are emulsion particles.

12. The water-based ink for ink-jet recording according to claim 1, further comprising a colorant.

13. The water-based ink for ink-jet recording according to claim 1, further comprising resin minute particles,
wherein the surfactant includes an acetylene glycol-based surfactant;
the water-soluble organic solvent includes propylene glycol; and
a content amount of the water-soluble organic solvent in the entire amount of the water-based ink is not less than 20% by mass.

14. The water-based ink for ink-jet recording according to claim 1, further comprising resin minute particles,
wherein the surfactant includes an acetylene glycol-based surfactant;
the water-soluble organic solvent includes 1,3-buthanediol; and
a content amount of the water-soluble organic solvent in the entire amount of the water-based ink is not less than 20% by mass.

15. The water-based ink for ink-jet recording according to claim 1, further comprising resin minute particles,
wherein the surfactant includes a polyoxyethylene-based surfactant;
the water-soluble organic solvent includes propylene glycol; and
a content amount of the water-soluble organic solvent in the entire amount of the water-based ink is not less than 20% by mass.

16. The water-based ink for ink-jet recording according to claim 1, further comprising resin minute particles,
wherein the surfactant includes a polyoxyethylene-based surfactant;
the water-soluble organic solvent includes 1,3-butanediol; and
a content amount of the water-soluble organic solvent in the entire amount of the water-based ink is not less than 20% by mass.

17. An ink-jet recording apparatus comprising:
an ink storage storing the water-based ink for ink-jet recording as described in claim 1; and
an ink-jet head configured to discharge the ink stored in the ink storage.

18. The ink jet recording apparatus according to claim 17, further comprising a drying mechanism configured to dry a recording part recorded by the ink.

19. An ink-jet recording method comprising discharging, onto a recording medium, the water-based ink for ink-jet recording as defined in claim 1.

20. The ink-jet recording method according to claim 19, further comprising drying a recording part of the recording medium by a drying mechanism.

21. The ink jet recording method according to claim 20, wherein in the drying of the recording part of the recording medium, a drying temperature is in a range of 20° C. to 200° C.

22. The ink-jet recording method according to claim 20, wherein in the drying of the recording part of the recording medium, a drying temperature is in a range of 50° C. to 100° C.
